(19) United States
(12) Patent Application Publication
(10) Pub. No.: US 2026/0061979 A1
(43) Pub. Date: Mar. 5, 2026

(54) GENERATING TRAJECTORIES FOR TRANSITIONING FROM DECELERATIONS

(71) Applicant: Zoox, Inc., Foster City, CA (US)

(72) Inventors: Varun Agrawal, Mountain View, CA (US); Vincent Andreas Laurense, Burlingame, CA (US); Glenn Xavier Liem, San Francisco, CA (US); Jiayin Xia, Santa Clara, CA (US)

(73) Assignee: Zoox, Inc., Foster City, CA (US)

(21) Appl. No.: 18/821,195

(22) Filed: Aug. 30, 2024

(51) Int. Cl. B60T 8/58; B60T 8/171; B60T 8/172

(52) U.S. Cl. CPC B60T 8/58; B60T 8/171; B60T 8/172; B60T 2210/10; B60T 2210/20; B60T 2210/30; B60T 2240/00; B60T 2250/00; B60T 2250/02; B60T 2250/04; B60T 2270/60

(57) ABSTRACT

A vehicle trajectory for transitioning out of a deceleration trajectory may be determined based on predicted vehicle state(s) and/or environmental condition(s). A determination about whether to transition into the determined trajectory may be based on whether the condition that triggered the deceleration trajectory still exists, whether the determined trajectory meets safety criteria, and/or whether an alternative deceleration trajectory is warranted. The determination may be used to determine which trajectory to control the vehicle and/or to inform the vehicle's driving behavior.

### BACKGROUND

Vehicles may be equipped with systems used to detect objects in an environment and control the vehicle to avoid the objects. Vehicles may also be equipped with a trajectory planning system that determines a trajectory for the vehicle under various conditions, such as when an obstacle is detected in the path of the vehicle. However, continuing contingent operations once those conditions have been ameliorated or resolved may yield unsafe and/or undesired outcomes.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 provides a flowchart diagram of an example process for determining a recovery trajectory for transitioning out of a maximum deceleration trajectory.

FIG. 2 provides an operational example of three longitudinal acceleration profiles.

FIG. 3 provides an operational example of determining whether to control a vehicle based on a recovery trajectory.

FIG. 4 is a flowchart diagram of an example process for conditionally controlling a vehicle based on a recovery trajectory.

FIG. 5 depicts a block diagram of an example system for implementing the techniques described herein.

### DETAILED DESCRIPTION

This disclosure describes techniques related to performing a deceleration using a vehicle. For example, the techniques described herein may include determining when and/or how to transition out of a deceleration trajectory associated with a vehicle. In some cases, the techniques described herein include: (i) causing a vehicle to be controlled based on a deceleration trajectory (e.g., a maximum deceleration trajectory) that may have been a safety trajectory for a first trajectory (e.g., which, in some examples, may have been triggered based on a fault, obstacle, sensor error, and/or the like), (ii) determining a “recovery trajectory” to transition out of the deceleration trajectory, and/or (iii) determining whether to control the vehicle based on the recovery trajectory. The deceleration trajectory may be adopted based on detecting a condition and/or may include applying a maximum bake force to the vehicle's brakes, which may result in the vehicle decelerating at the maximum possible deceleration rate. The recovery trajectory may be configured to smoothly transition the vehicle back to a nominal (e.g., nominally produced) trajectory. The safety trajectory may, for example, be generated by a secondary system (e.g., as described below) that is configured to validate a trajectory (e.g., a nominal trajectory) generated by a primary system (e.g., as described below) and/or generate a safety trajectory (e.g., as described below) for controlling the vehicle. The deceleration trajectory may include at least one of a maximum deceleration trajectory that includes causing a vehicle to apply a maximum deceleration and/or a non-maximum deceleration that includes causing a vehicle to apply a non-maximum deceleration (e.g., where the non-maximum deceleration may have a lower magnitude relative to the maximum deceleration). Generating the recovery trajectory may be based on the vehicle's predicted velocity at a period after applying the deceleration, for example as determined based on: (i) a vehicle's measured velocity at a time associated with applying the deceleration, and/or (ii) a predicted change in the measured velocity resulting from the deceleration. For example, the recovery trajectory may be associated with: (i) an acceleration profile that is determined based on the predicted change in the measured velocity, and/or (ii) a lateral motion profile that is determined based on the lateral motion profile of the controlling trajectory associated with the time at which the brake force was first applied. The recovery trajectory may be a candidate trajectory for transitioning out of a maximum deceleration trajectory.

In some cases, the system (e.g., a primary system, for example as described below) is configured to determine a nominal trajectory for controlling the vehicle. The system may determine the nominal trajectory based on an acceleration and/or a deceleration (e.g., a longitudinal acceleration and/or deceleration) that is within an acceleration limit (e.g., a nominal acceleration limit). For example, the acceleration limit may be associated with an upper-bound acceleration (e.g., an upper-bound acceleration of 2.5 meters per seconds squared) and a lower-bound deceleration (e.g., a lower-bound acceleration of −5.5 meters per seconds squared). This may mean that the nominal trajectory cannot at any point accelerate more than 2.5 meters per seconds squared and/or decelerate more than 5.5 meters per seconds squared. In some cases, the system continues controlling the vehicle based on the nominal trajectory until the system (e.g., a secondary system, for example as described below) determines that the nominal trajectory is expected to lead to a failure (e.g., an internal vehicle failure, a collision, and/or the like).

In some cases, based on determining that the nominal trajectory is expected to lead to failure (e.g., a collision and/or a system failure), the system (e.g., the secondary system) selects whether to control the vehicle based on a maximum deceleration trajectory or a non-maximum deceleration trajectory. The system may determine whether to control the vehicle based on the maximum deceleration trajectory or the non-maximum deceleration trajectory in accordance with one or more criteria. Examples of such criteria may include the timing of the determination, the severity of the expected failure, the likelihood of expected failure, and the current operating conditions of the vehicle. For example, in some cases, the system: (i) controls the vehicle based on the non-maximum deceleration trajectory for a period of time, (ii) during and/or after the period, determines whether a likelihood of failure exceeds a threshold, (iii) based on determining that the likelihood fails to exceed the threshold, stops controlling the vehicle based on the non-maximum deceleration trajectory (e.g., starts controlling the vehicle based on a recovery trajectory for transitioning out of the non-maximum deceleration trajectory), and/or (iv) based on determining that the likelihood exceeds the threshold, controls the vehicle based on the maximum deceleration trajectory. The period of time may be a predefined time period and/or may be dynamically determined. For example, the period of time may be a period in which the vehicle's jerk (e.g., the rate of change of the vehicle's deceleration) is at a jerk limit associated with the vehicle.

As another example, in some cases, the system controls the vehicle based on the non-maximum deceleration trajectory if the failure likelihood associated with the vehicle and/or the vehicle's environment exceeds a first threshold and/or based on the maximum deceleration trajectory if the failure likelihood associated with the vehicle and/or the vehicle's environment exceeds a second threshold. The second threshold may exceed the second threshold.

As another example, in some cases, the system controls the vehicle based on the non-maximum deceleration trajectory if the failure severity associated with the vehicle and/or the vehicle's environment exceeds a first threshold and/or based on the maximum deceleration trajectory if the failure severity associated with the vehicle and/or the vehicle's environment exceeds a second threshold. The second threshold may exceed the second threshold.

In some cases, the deceleration associated with the non-maximum deceleration trajectory is determined based on (e.g., equals) the lower-bound deceleration associated with the vehicle's nominal acceleration limit (e.g., as described above). In some cases, the deceleration associated with the maximum deceleration trajectory is higher in magnitude (e.g., lower in value) than the lower-bound deceleration associated with the vehicle's nominal acceleration limit (e.g., as described above). For example, in some cases, the deceleration associated with the non-maximum deceleration trajectory is −5.5 meters per seconds squared and/or the deceleration acceleration with the maximum deceleration trajectory is higher in magnitude (e.g., lower in value) than −5.5 meters per seconds squared. In some cases, the magnitude of the deceleration associated with the maximum deceleration trajectory exceeds the magnitude of the deceleration associated with the non-maximum deceleration trajectory and/or the magnitude(s) of any deceleration(s) associated with a nominal trajectory. In some cases, the magnitude of the deceleration associated with the maximum deceleration trajectory is determined based on (e.g., equals) the deceleration resulting from applying a maximum braking to the vehicle (e.g., as determined based on one or more vehicle conditions and/or one or more vehicle environmental conditions).

In some cases, a secondary system sends data describing that the vehicle is being controlled in accordance with a safety trajectory (e.g., a maximum deceleration trajectory and/or a non-maximum deceleration trajectory) to a primary system. The primary system may use such data to determine a recovery trajectory for transitioning out of the safety trajectory (e.g., into nominal operations), for example using the techniques described herein for generating a recovery trajectory. The primary system may then send the recovery trajectory to the secondary system. The secondary system may then determine whether to transition out of the safety trajectory and/or into the recovery trajectory, for example using the techniques described herein for determining whether to transition out of the safety trajectory and/or into the recovery trajectory.

In some cases, a maximum deceleration trajectory is an example of a safety trajectory (e.g., a non-nominal trajectory, which may be a trajectory other than a nominal trajectory). A safety trajectory may be any trajectory that is used to control the vehicle based on determining that the vehicle is in a high-risk situation and/or based on determining that following the vehicle's existing trajectory (e.g., existing nominal trajectory) likely leads to a failure (e.g., that following the existing trajectory leads to a failure probability that exceeds a threshold, insufficient data to ensure safe trajectory generation—e.g., loss of sensor data, loss of compute, faults in one or more systems, or subsystems, etc.). A safety condition may be any condition that, when detected, causes controlling of the vehicle in accordance with an safety trajectory. In some cases, a safety trajectory may be a “non-maximum deceleration” trajectory and/or a “maximum deceleration” trajectory, as further described below. An example of a failure is a collision and a component failure (e.g., a critical component failure, a sensor failure, and/or the like).

In some cases, a vehicle trajectory represents a potential motion pattern for a vehicle to follow. A vehicle trajectory may be associated with one or more motion profiles and/or one or more acceleration profiles. For example, a vehicle trajectory may be associated with a lateral motion profile and/or a longitudinal acceleration profile. A lateral motion profile associated with a trajectory may represent a change in a lateral position of a vehicle (e.g., a position in a lateral direction) if the vehicle is controlled in accordance with the trajectory. The lateral motion profile may, for example, represent a steering and/or sideways movement pattern. A longitudinal acceleration profile associated with a trajectory may represent a change in the vehicle's longitudinal direction velocity (e.g., the vehicle's velocity in a longitudinal direction, such as a longitudinal direction that is normal to the lateral direction) if the vehicle is controlled in accordance with the trajectory. The longitudinal acceleration profile may, for example, represent a change in the vehicle's speed including accelerations, decelerations, braking controls, and/or periods of constant speed. Example lateral motion profiles and/or longitudinal acceleration profiles are described in US Pat. App. Pub. No. 20240051573, entitled “Systems and Methods for Controlled Deceleration” and filed on Aug. 15, 2022 and/or in US Pat. App. Pub. No. 20240034308, entitled “Systems and Methods for Rapid Deceleration” and filed on Jul. 7, 2022, both of which are incorporated by reference herein in their entirety and for all purposes.

In some cases, when a non-maximum deceleration trajectory is associated with a predetermined longitudinal acceleration profile. In some cases, a maximum deceleration trajectory is not associated with a predetermined longitudinal acceleration profile. In some cases, the predetermined longitudinal acceleration profile associated with a non-maximum deceleration trajectory is determined based on a lower-bound deceleration defined by a nominal deceleration limit.

In some cases, to determine the maximum deceleration trajectory, the system may determine a lateral motion profile but may refrain from determining a longitudinal acceleration profile. Instead, the system may determine to apply a maximum deceleration (e.g., a maximum braking force) while controlling the vehicle's lateral position in accordance with the predetermined lateral motion profile.

In some cases, to determine the non-maximum deceleration trajectory, the system may determine a lateral motion profile and a longitudinal acceleration profile, such as a longitudinal acceleration profile that reduces the vehicle's velocity in accordance with a predefined deceleration pattern (e.g., where the magnitude of the deceleration associated with this predefined deceleration pattern may be lower than the magnitude of the maximum deceleration associated with a maximum deceleration trajectory). The non-maximum deceleration trajectory may be associated with a non-maximum braking. In some cases, controlling the vehicle based on a maximum deceleration trajectory (e.g., based on maximum deceleration) is based on determining that a non-maximum deceleration trajectory (e.g., non-maximum deceleration) is insufficient for responding to a safety condition (e.g., a detected failure-related event).

Accordingly, in some cases, based on (e.g., in response to) detecting a safety condition (e.g., any condition that may trigger transitioning out of a nominal trajectory being used to control the vehicle and/or transitioning into a safety trajectory for controlling the vehicle), the system may control the vehicle in accordance with a safety trajectory selected from a set of safety trajectories. The set of safety trajectories may include one or more “non-maximum” deceleration trajectories and/or one or more “maximum” deceleration trajectories. A maximum deceleration trajectory may reduce the longitudinal acceleration of the vehicle in a “maximum” manner and/or in accordance with a predetermined longitudinal acceleration profile. An example of a maximum deceleration trajectory is described in US Pat. App. Pub. No. 20240051573, entitled “Systems and Methods for Controlled Deceleration” and filed on Aug. 15, 2022, which is incorporated by reference herein in its entirety and for all purposes. A non-maximum deceleration trajectory may reduce the longitudinal acceleration of the vehicle in a “non-maximum” manner and/or in accordance with a heightened and/or maximum deceleration rate. An example of a non-maximum deceleration trajectory is described in US Pat. App. Pub. No. 20240034308, entitled “Systems and Methods for Rapid Deceleration” and filed on Jul. 7, 2022, which is incorporated by reference herein in its entirety and for all purposes. In some cases, the magnitude of the deceleration (e.g., maximum deceleration) associated with a non-maximum safety trajectory exceeds the magnitude of the deceleration associated with a maximum safety trajectory and/or the magnitude of the deceleration and/or acceleration associated with a nominal trajectory.

In some cases, a first vehicle component (e.g., a primary system, for example as further described below) may be configured to generate nominal trajectories and/or control the vehicle based on the generated nominal trajectory (e.g., control the vehicle based on the generated nominal trajectory based on a detection that no safety condition exists). In some cases, a second vehicle component (e.g., a secondary system, for example as described below) may be configured to generate safety trajectories and/or control the vehicle based on the generated safety trajectory (e.g., control the vehicle based on the generated safety trajectory based on a determining that a safety condition exists). Examples of nominal trajectories include: (i) a nominal trajectory used to control the vehicle in the absence of detecting an safety condition, and (ii) a nominal trajectory (e.g., a recovery trajectory) used to transition out of an safety trajectory (e.g., transition out of an safety trajectory based at least in part on determining that a safety condition exists). Examples of safety trajectories include non-maximum safety trajectories (e.g., a maximum deceleration trajectory) and/or maximum safety trajectories (e.g., a non-maximum deceleration trajectory). In some cases, determining whether a safety condition exists is performed based on the vehicle's environment and/or by at least one of the first vehicle component or the second vehicle component (e.g., by the second vehicle component).

In some cases, a first vehicle component (e.g., a primary system, for example as further described below) may be configured to determine a first nominal trajectory for controlling the vehicle. In some cases, at a first time, the vehicle may be controlled in accordance with the first nominal trajectory. In some cases, at a second time, a second vehicle component (e.g., a secondary system, for example as described below) may be configured to detect an safety condition. In some cases, based on detecting the safety condition at the second time, the second vehicle component may be determined in accordance with a safety trajectory. For example, the second vehicle component may determine and/or select a safety trajectory (e.g., a maximum and/or non-maximum deceleration trajectory, such as a non-maximum and/or maximum deceleration trajectory), and the vehicle may then be controlled in accordance with the determined and/or selected safety trajectory. In some cases, at a third time after the second time, the first vehicle component may be configured to determine a second nominal trajectory for transitioning out of the safety trajectory. The second vehicle component may then be configured to determine whether to: (i) continue to control the vehicle in accordance with the safety trajectory (e.g., based at least in part on determining whether a safety condition exists), (ii) control the vehicle in accordance with the second nominal trajectory, or (iii) control the vehicle in accordance with another safety trajectory.

For example, a vehicle may include a primary system for controlling the vehicle and a secondary system that operates on the vehicle to validate operation of the primary system and to control the vehicle to avoid failures. The secondary system may receive one or more trajectories from the primary system, such as a primary trajectory and a secondary trajectory (e.g., a safety trajectory associated with a deceleration or other maneuver). The secondary system may validate each trajectory (e.g., determine if an error exists). For example, the secondary system may determine if a trajectory generated by the primary system is associated with a potential failure, if the trajectory is consistent with a current or previous pose of the vehicle, if the trajectory is compatible with a capability of the vehicle, and/or the like. If a primary trajectory is valid, the secondary system may control the vehicle according to the primary trajectory. If the primary trajectory is invalid, and a secondary trajectory is valid, the secondary system may control the vehicle according to the secondary trajectory. If the primary trajectory and the secondary trajectory are both invalid, the secondary system may use another trajectory to control the vehicle, such as a safety trajectory and/or a deceleration trajectory. The primary system may generally perform processing to control how the vehicle maneuvers within an environment. The primary system may implement various Artificial Intelligence (AI) techniques, such as machine learning, to understand an environment around the vehicle and/or instruct the vehicle to move within the environment. The secondary system may generally evaluate the primary system using at least a subset of data (e.g., sensor data) made available to the primary system. For example, the secondary system may independently localize the vehicle by determining a position and/or orientation (together a pose) of the vehicle relative to a point and/or object in an environment where the vehicle is located. Examples of primary system and/or secondary system operations are described in U.S. Pat. No. 11,104,332, entitled “Collision Avoidance System with Trajectory Validation” and filed on Dec. 12, 2018, which is incorporated by reference herein in its entirety and for all purposes.

In some cases, the secondary system may detect a safety condition, for example based on determining that a vehicle's controlling trajectory is likely to lead to failure. Based on detecting the safety condition, the secondary system may determine whether to control the vehicle based on a maximum deceleration trajectory (e.g., without a predetermined longitudinal acceleration profile) and/or based on a non-maximum deceleration trajectory (e.g., with a predetermined longitudinal acceleration profile). For example, the secondary system may determine to control the vehicle based on a maximum deceleration trajectory and/or cause the vehicle to apply a maximum deceleration (e.g., apply a maximum braking force). The primary system may then determine a “recovery trajectory” for transitioning out of the maximum deceleration trajectory. After the primary system determines the recovery trajectory, the secondary system may determine whether to transition from the maximum deceleration trajectory onto the recovery trajectory. For example, the secondary system may determine to transition from the maximum deceleration trajectory onto the recovery trajectory based on determining: (i) that the safety condition that caused adopting the maximum deceleration trajectory no longer exists, (ii) that the recovery trajectory is safe (e.g., that a safety score associated with the recovery trajectory exceeds a threshold), and/or (iii) that a condition of the vehicle's environment does not require transitioning into the non-maximum deceleration trajectory. In some cases, if the secondary system decides to transition out of the maximum deceleration trajectory into the recovery trajectory, the vehicle is controlled based on the recovery trajectory.

In some cases, the techniques described herein include at least one of the following: (i) determining whether to control a vehicle based on a maximum deceleration trajectory, (ii) determining a recovery trajectory for transitioning from a maximum deceleration trajectory, and/or (iii) determining whether to control the vehicle based on the recovery trajectory. In some cases, operations (i) and (iii) are performed by the second vehicle component, while operation (ii) is performed by the first vehicle component. Aspects of these operations are described in greater detail below.

In some cases, determining whether to control a vehicle based on a maximum deceleration trajectory is based on at least one of: (i) determining that a safety condition exists, or (ii) determining not to control the vehicle based on the non-maximum deceleration trajectory. For example, in some cases, the system controls a vehicle based on the maximum deceleration trajectory based on determining that a safety condition exists and to refrain from controlling the vehicle based on the non-maximum deceleration trajectory (e.g., to instead control the vehicle based on the maximum deceleration trajectory).

In some cases, the system determines that a safety condition exists based on determining that the likelihood of an imminent failure between the vehicle and another object (e.g., another vehicle) exceeds a first threshold. Example techniques for determining an imminent failure likelihood are described in US Pat. App. Pub. No. 20200211394, entitled “Failure Avoidance System” and filed on Dec. 26, 2018; in U.S. Pat. No. 11,104,332, entitled “Failure Avoidance System with Trajectory Validation” and filed on Dec. 12, 2018; and/or in U.S. Pat. No. 11,124,185, entitled “Perception Collision Avoidance” and filed on Nov. 11, 2018, all of which are incorporated by reference herein in their entirety and for all purposes. In some cases, the system determines to control the vehicle based on a maximum deceleration trajectory based on determining that the imminent failure probability exceeds a second threshold, where the second threshold exceeds the first threshold. In some cases, the system determines to control the vehicle based on a non-maximum deceleration trajectory based on determining that the imminent failure probability exceeds the first threshold but not the second threshold.

In some cases, the system determines to control the vehicle based on determining that the likelihood of an imminent potential failure exceeds a threshold. In some cases, the system determines to control the vehicle based on determining that the likelihood of a non-imminent potential failure exceeds a threshold. Example techniques for determining imminent failure likelihoods and/or non-imminent failure likelihoods are described in US Pat. App. Pub. No. 20240051573, entitled “Systems and Methods for Controlled Deceleration” and filed on Aug. 15, 2022 and/or in US Pat. App. Pub. No. 20240034308, entitled “Systems and Methods for Rapid Deceleration” and filed on Jul. 7, 2022, both of which are incorporated by reference herein in their entirety and for all purposes.

In some cases, the system determines a recovery trajectory for transitioning out of a safety trajectory such as a maximum deceleration trajectory. In some cases, to determine the recovery trajectory, the system determines: (i) a lateral motion profile for transitioning out of the safety trajectory, and/or (ii) a longitudinal acceleration profile for transitioning of the safety trajectory. In some cases, the lateral motion profile for the recovery trajectory is determined based on the lateral motion profile associated with a nominal trajectory that precedes the adoption of the nominal trajectory.

For example, while a vehicle is being controlled in accordance with a nominal trajectory T1, the system (e.g., a component of the system, such as the secondary system described above) may determine that a safety condition exists (e.g., that a need for adopting a safety trajectory exists). Based on this determination, the system (e.g., a component of the system, such as the secondary system described above) may control the vehicle based on a safety trajectory (e.g., a maximum deceleration trajectory) T2. In some cases (e.g., substantially simultaneously with and/or after the system starts controlling the vehicle based on T2), the system (e.g., a component of the system, such as the primary system described above) may generate a recovery trajectory T3 for transitioning out of T2. In some cases, the lateral motion profile associated with T2 and/or the lateral motion profile associated with T3 may be determined based on T1's lateral motion profile.

Accordingly, a recovery trajectory's lateral motion profile is determined based on the lateral motion profile of a preceding nominal trajectory that is associated with the recovery trajectory (e.g., the lateral motion profile of the nominal trajectory associated with the safety trajectory that is in turn associated with the recovery trajectory, the lateral motion profile of the most recent preceding nominal trajectory, and/or the like). In some cases, a recovery trajectory's lateral motion profile includes all and/or a portion of the corresponding preceding nominal trajectory's lateral motion profile.

For example, in some cases, a recovery trajectory associated with (e.g., generated at and/or in relation to) a time M1 may include a portion of the preceding nominal trajectory's lateral motion profile, such as a portion that is associated with a time range that starts at M2=M1+R. R may be a predefined and/or dynamically determined delay period. The delay period may, for example, include: (i) an expected and/or measured period associated with a determination as to whether a safety condition exists and/or whether a transition out of the controlling safety trajectory should occur, and/or (ii) an expected and/or measured associated with whether to transition into the recovery trajectory. In some cases, after determining M2, the system may determine a portion of the preceding lateral motion profile that is associated with a time range starting at M2. The system may then adopt that lateral motion profile as the recovery trajectory's lateral motion.

As another example, in some cases, to determine a recovery trajectory associated with a time M1, the system: (i) determines a position P1 representing where the vehicle is predicted to be at M2 (e.g., where M2=M1+R, for example as described above) in accordance with the preceding nominal trajectory assuming the vehicle was still being controlled in accordance with that preceding trajectory, (ii) determines a position P2 representing where the vehicle is predicted to be at M2 in accordance with the controlling safety trajectory, and (iii) determines a recovery trajectory based on the preceding lateral motion profile as well as the deviation between P1 and P2. For example, the system may determine a recovery trajectory that first smoothly transitions from P2 to P1 and then follows the lateral motion profile of the preceding nominal trajectory starting from a time associated with P1 onwards. As another example, the system may determine a recovery trajectory that smoothly transitions to a point along with the preceding trajectory and then controls the vehicle in accordance with a portion of the preceding lateral motion profile that starts at a time associated with the point. Example techniques for determining P1 and/or P2 are described in greater detail below.

In some cases, to determine P1 (e.g., a predicted longitudinal position assuming the preceding nominal trajectory), the system determines the point on the preceding trajectory that corresponds to M2 and determines P1 based on that determined point. In some cases, to determine P2 (e.g., a predicted longitudinal position assuming the current safety trajectory), the system predicts where the vehicle will be at M2 given: (i) the lateral motion profile of the safety trajectory associated with a time period between M1 and M2, and (ii) a predicted deceleration pattern associated with that period. The predicted deceleration pattern may represent one or more predicted velocities associated with one or more times in target period given maximum deceleration (e.g., maximum deceleration). Example techniques for determining a predicted velocity associated with maximum deceleration are described in greater detail below, for example in relation to determining the recovery trajectory's longitudinal acceleration profile.

In some cases, to determine the longitudinal acceleration profile associated with a recovery trajectory, the system: (i) determines a predicted velocity associated with a second time after a first time associated with controlling the vehicle in accordance with a maximum deceleration trajectory, and (ii) determines the longitudinal acceleration profile based on the predicted velocity (e.g., based on an assumption that the vehicle's velocity equals to the predicted velocity at the beginning of the recovery trajectory). In some cases, to determine the predicted velocity associated with the second time, the system: (i) determines a measured velocity associated with the first time (e.g., based on a sensor value, such as a speedometer value, a geolocation sensor value, and/or the like), and (ii) determines the predicted velocity based on the maximum deceleration and the measured velocity. For example, the system may determine the predicted velocity by reducing the measured velocity in accordance with a predicted maximum deceleration rate and a length of time between the first time and the second time. The first time may be determined based on (e.g., may be) a current time, a time associated with a latest velocity measurement, a time associated with a latest determination about which trajectory to use to control the vehicle, a time associated with a latest determination about whether to control the vehicle based on the existing maximum deceleration trajectory, and/or the like. The second time may be determined based on a delay period after the first time. Example techniques for determining and/or computing the delay period are described above. Example techniques for determining maximum deceleration rate (e.g., based on vehicle condition(s) and/or vehicle environment condition(s)) are described below.

For example, the system may determine that a vehicle may be controlled in accordance with the maximum deceleration trajectory at time M1. The system may then determine that the vehicle has a measured velocity of V1 at M1. The system may then determine the maximum deceleration rate (a_max) associated with a period including M1 and a subsequent time M2, which is D time units after M. The system may then determine a predicted velocity V2 associated with M2 based on V1, D, and a_max (e.g., using V2=V1−(a_max*D)). The system may then determine the recovery trajectory's longitudinal acceleration profile by assuming that the vehicle will have a velocity of V2 at M2. For example, the system may determine a longitudinal acceleration profile associated with the recovery trajectory that causes the vehicle to maintain a velocity within a threshold region of V2 for a predefined period of time after M2. As another example, the system may determine a longitudinal acceleration profile associated with the recovery trajectory that causes the vehicle to smoothly increase the vehicle's velocity from V2 at M2 to a V3 at a subsequent time M3. V3 may, for example, be determined based on a portion of longitudinal acceleration profile of the preceding nominal trajectory that is associated with M3. The length of time between M2 and M3 may, for example, be determined based on a magnitude of deviation between V2 and a predicted velocity associated with M2 if the vehicle had been controlled in accordance with the preceding nominal trajectory.

Accordingly, as described above, the system may determine the longitudinal acceleration profile associated with a recovery trajectory based on a predicted velocity associated with a subsequent time. The system may further determine the predicted velocity associated with a subsequent time based on a maximum deceleration rate associated with a subsequent period including the subsequent time. In some cases, the maximum deceleration rate is a fixed value (e.g., a fixed vehicle-specific value).

In some cases, the system may determine the maximum deceleration rate associated with a subsequent period based on and/or a measurement (e.g., a current and/or past measurement) about a vehicle environment condition. For example, the system may determine the maximum deceleration rate associated with a period based on measurement(s) about a road incline, a road surface type, a road condition, a weather condition, a wind condition, an air density, an air temperature, an air pressure, an engine temperature, a vehicle altitude, a tire condition, a weight associated with the vehicle, a vehicle fuel quality, availability of regenerative braking (e.g., whether the vehicle has regenerative braking functionality and/or whether this functionality is available and/or operational), a condition of the vehicle's braking system (e.g., whether the vehicle's braking system is operational), and/or a condition associated with a suspension control of the vehicle (e.g., whether the vehicle's suspension control is available). In some cases, the system determines the maximum deceleration rate associated with a period by processing measurement(s) using a statistical model and/or a trained machine learning model.

In some cases, the system determines a maximum deceleration rate based on a road incline. For example, when a vehicle is traveling downhill on a steep grade, the maximum safe deceleration rate may be lower than when the vehicle is traveling on a flat road.

In some cases, the system determines a maximum deceleration rate based on a road surface type. For example, when a vehicle is traveling on a gravel road, the maximum safe deceleration rate may be lower than when the vehicle is traveling on a paved asphalt surface.

In some cases, the system determines a maximum deceleration rate based on a road condition. For example, when a vehicle is traveling on a road with potholes and/or uneven surfaces, the maximum safe deceleration rate may be lower than when the vehicle is traveling on road without potholes and/or uneven surfaces.

In some cases, the system determines a maximum deceleration rate based on a weather condition. For example, when a vehicle is traveling in heavy rain and/or snow, the maximum safe deceleration rate may be lower than when the vehicle is traveling in clear weather conditions.

In some cases, the system determines a maximum deceleration rate based on a wind condition. For example, when a vehicle is traveling against strong headwinds, the maximum safe deceleration rate may be higher than when the vehicle is traveling without strong headwinds.

In some cases, the system determines a maximum deceleration rate based on air density. For example, when a vehicle is traveling in areas with lower air density (e.g., high altitudes), the maximum safe deceleration rate may be higher than when the vehicle is traveling in areas with higher air density (e.g., at sea level).

In some cases, the system determines a maximum deceleration rate based on air temperature. For example, when a vehicle is traveling in cold temperatures, the maximum safe deceleration rate may be lower (e.g., due to potential ice formation on road surfaces) than when the vehicle is traveling in areas with hot temperatures.

In some cases, the system determines a maximum deceleration rate based on engine temperature. For example, when a vehicle's engine is operating at higher temperatures, the maximum safe deceleration rate may be lower than when the vehicle's engine is operating at lower temperatures.

In some cases, the system determines a maximum deceleration rate based on tire condition. For example, when a vehicle's tires have reduced tread depth and/or uneven wear, the maximum safe deceleration rate may be lower than when the tires are in optimal condition.

In some cases, the system determines a maximum deceleration rate based on vehicle weight. For example, when a vehicle is carrying a heavy load, the maximum safe deceleration rate may be lower than when the vehicle is operating without a heavy load.

In some cases, the system determines a maximum deceleration rate based on vehicle fuel quality. For example, when a vehicle is operating with lower-quality fuel, the maximum safe deceleration rate may be lower than when the vehicle is operating with higher-quality fuel.

In some cases, after the system determines a recovery trajectory to transition out of a maximum deceleration trajectory, the system determines whether to transition out of the maximum deceleration trajectory into the recovery trajectory. This determination may be based on: (i) whether a “triggering” event (e.g., an safety condition) that caused transition to an safety trajectory and/or to the maximum deceleration trajectory exists, (ii) whether to transition into a non-maximum deceleration trajectory instead of to recovery trajectory, and/or (iii) a score (e.g., a safety score, such as a numeric safety score and/or a categorical safety determination) associated with the recovery trajectory. For example, the system may determine to transition into the recovery trajectory if: (i) the event that caused transition to an safety trajectory and/or to the maximum deceleration trajectory no longer exists, (ii) a transition to a non-maximum deceleration trajectory is not warranted (e.g., non-maximal braking is not needed to respond to the safety condition), and/or (iii) a safety score associated with the recovery trajectory represents that the recovery trajectory is safe (e.g., the safety score exceeds a threshold and/or represents an affirmative categorical determination).

In some cases, determining whether the triggering event exists is based on determining whether the vehicle is likely to experience a failure and/or an imminent failure. In some cases, determining whether to transition from a maximum deceleration trajectory into a non-maximum deceleration trajectory is based on whether the vehicle is expected to experience a non-imminent failure. Example techniques for determining imminent failure likelihoods and/or non-imminent failure likelihoods are described above.

In some cases, determining a score (e.g., a cost) associated with a recovery trajectory includes determining a score representing whether and/or how much the recovery trajectory is safe. In some cases, determining whether a recovery trajectory score includes evaluating the recovery trajectory. Example techniques for determining a trajectory score and/or evaluating (e.g., validating) a trajectory are provided in U.S. Pat. No. 11,215,997, entitled “Probabilistic Risk Assessment for Trajectory Evaluation” and filed on Nov. 30, 2018; in U.S. Pat. No. 11,188,082, entitled “Occlusion Prediction and Trajectory Evaluation” and filed on Jan. 11, 2019; and/or in U.S. Pat. No. 11,407,409, entitled “System and Method for Trajectory Validation” and filed on Aug. 13, 2019, all of which are incorporated by reference herein in its entirety and for all purposes.

In some cases, the system determines a recovery trajectory's score based on: (i) the deviation between the predicted velocity at a subsequent time and the measured velocity at that subsequent time, and/or (ii) the deviation between the predicted position (e.g., the predicted longitudinal position) at the subsequent time and the measured position (e.g., the measured longitudinal position) at the subsequent time. The system may, for example, decrease the score as one or more of the described deviations becomes larger.

For example, a vehicle may have a measured velocity of V1 at a time M1, and may be controlled in accordance with a maximum deceleration trajectory at that time. The system may generate a recovery trajectory by computing and assuming that the vehicle will have a predicted velocity V2^{p} and will be at a position P2^{p} at a subsequent time M2. The system may then receive measurements representing that the vehicle has a velocity of V2^{m} and is at a position P2^{m} at M2. The system may then determine a score for the generated recovery trajectory based on one or more of: (i) a deviation between V2^{p} and V2^{m}), or (ii) a deviation between P2^{p} and P2^{m}. For example, the system may provide one or more of those deviations as inputs to a machine learning model and/or a statistical model used to determine and/or adjust a recovery trajectory score.

In some cases, the techniques and/or systems discussed herein may enhance the safety of passengers in a vehicle and/or other individuals in proximity to the vehicle. For example, the techniques described herein may increase the likelihood that a vehicle can transition from an safety trajectory into a nominal trajectory in a safe and/or smooth manner, while accounting for the changes in the position and/or velocity of the vehicle resulting from application of the nominal trajectory.

In some cases, the techniques described herein increase the redundancy of a vehicle computing device by equipping the device with two components for trajectory validation. In some cases, if one of those components fails, the other can take over, which increases the reliability of the vehicle computing device. This redundancy approach provides an additional layer of safety and continuity in the trajectory validation process. If a safety condition is detected or if a trajectory needs to be verified, both trajectory validation components work in parallel to independently assess and validate the trajectory. This simultaneous validation process increases the system's confidence in the accuracy and reliability of the trajectory, as any discrepancies or inconsistencies between the two components can be detected and resolved. Moreover, in the event of a failure in one of the components, the remaining component can continue performing trajectory validation without interruption, ensuring the vehicle's operations remain secure and unaffected by the failure.

The methods, apparatuses, and systems described herein may be implemented in a number of ways. Example implementations are provided below with reference to the following figures. Although discussed in the context of an autonomous vehicle, in some examples, the methods, apparatuses, and systems described herein may be applied to a variety of systems. In another example, the methods, apparatuses, and systems may be utilized in an aviation or nautical context. Additionally, or alternatively, the techniques described herein may be used with real data (e.g., captured using sensor(s)), simulated data (e.g., generated by a simulator), or any combination thereof.

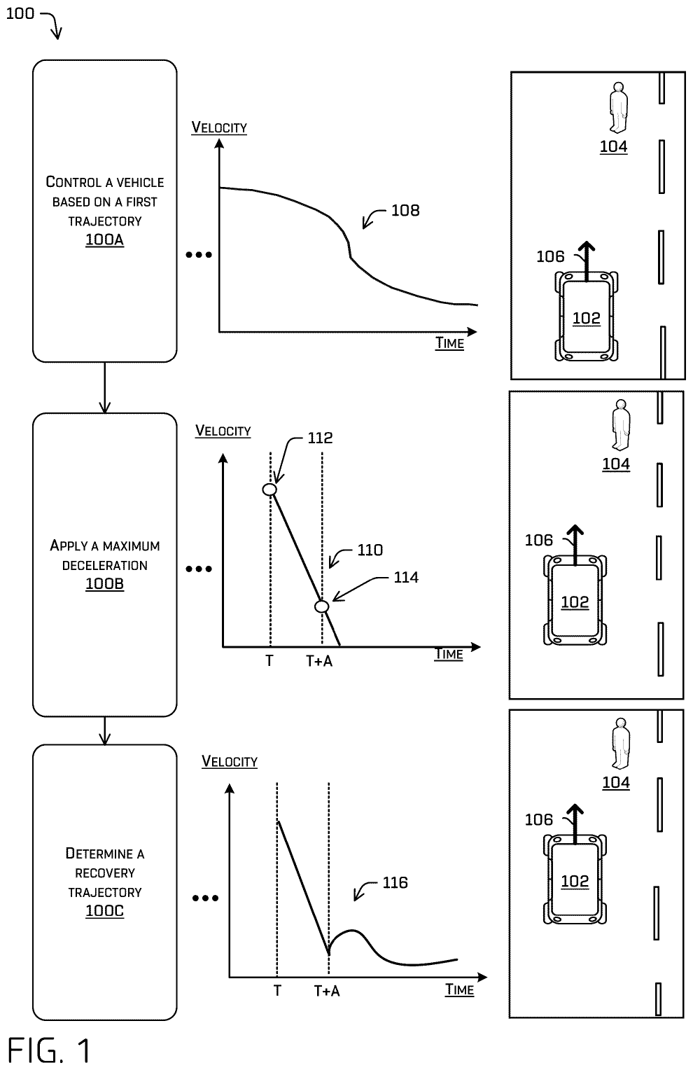

FIG. 1 provides a flowchart diagram of an example process 100 for determining a recovery trajectory for transitioning out of a maximum deceleration trajectory. As depicted in FIG. 1, at operation 100A, an example system controls a vehicle based on a first trajectory. The first trajectory may be a nominal trajectory in accordance with which a vehicle is being controlled when a safety condition is detected.

For example, as depicted in FIG. 1, a vehicle 102 is being controlled in accordance with a first trajectory that has the lateral motion profile 106 and the longitudinal acceleration profile 108. The lateral motion profile 106 represents that, in accordance with the first trajectory, the vehicle should not swerve and move straight. The longitudinal acceleration profile 108 represents a change in the vehicle's velocity in accordance with the first trajectory. As further depicted in FIG. 1, there is an object 104 (e.g., a pedestrian) in the vehicle's environment.

At operation 100B, the system applies a maximum deceleration, such as using a maximum braking force. The magnitude of the maximum deceleration may exceed the magnitude of an acceleration associated with the first trajectory and/or the magnitude of an acceleration associated with a non-maximum braking. In some cases, the system applies a maximum deceleration based on detecting that a likelihood of imminent failure of the vehicle with an object exceeds a threshold. In some cases, the maximum deceleration trajectory that includes the maximum deceleration is associated with the same lateral motion profile as the lateral motion profile of the first trajectory.

For example, as depicted in FIG. 1, the system may determine an imminent failure involving the vehicle 102 and object 104 at a time T. The system may apply the maximum deceleration 110. This maximum deceleration 110 may be expected to cause the vehicle's velocity to decrease from the measured velocity 112 at time T to the predicted velocity 114 at time T+A. The deviation between T and T+A may be associated with an expected required time for determining whether to transition out of the maximum deceleration 110 and/or whether to adopt a recovery trajectory. The deviation between T and T+A may, for example, be less than or equal fifty milliseconds. The maximum deceleration may be greater in magnitude than −5.5 meters per seconds squared, while the non-maximum deceleration may be 5.5 meters per seconds squared. As further depicted in FIG. 1, the maximum deceleration trajectory that includes the maximum deceleration 110 is associated with the same lateral motion profile as the lateral motion profile 106 of the first trajectory.

At operation 100C, the system determines a recovery trajectory for potentially transitioning out of the maximum deceleration trajectory. The recovery trajectory may be associated with the same lateral motion profile as that of the first trajectory. The recovery trajectory may be associated with a longitudinal acceleration profile that is determined based on (e.g., that includes, that begins with, and/or the like) the predicted velocity associated with a subsequent time. For example, as depicted in FIG. 1, the recovery trajectory is associated with the same lateral motion profile as the lateral motion profile 106 of the first trajectory. As further depicted in FIG. 1, the recovery trajectory is associated with a longitudinal motion profile 116 that includes the predicted velocity 114 associated with the time T+A.

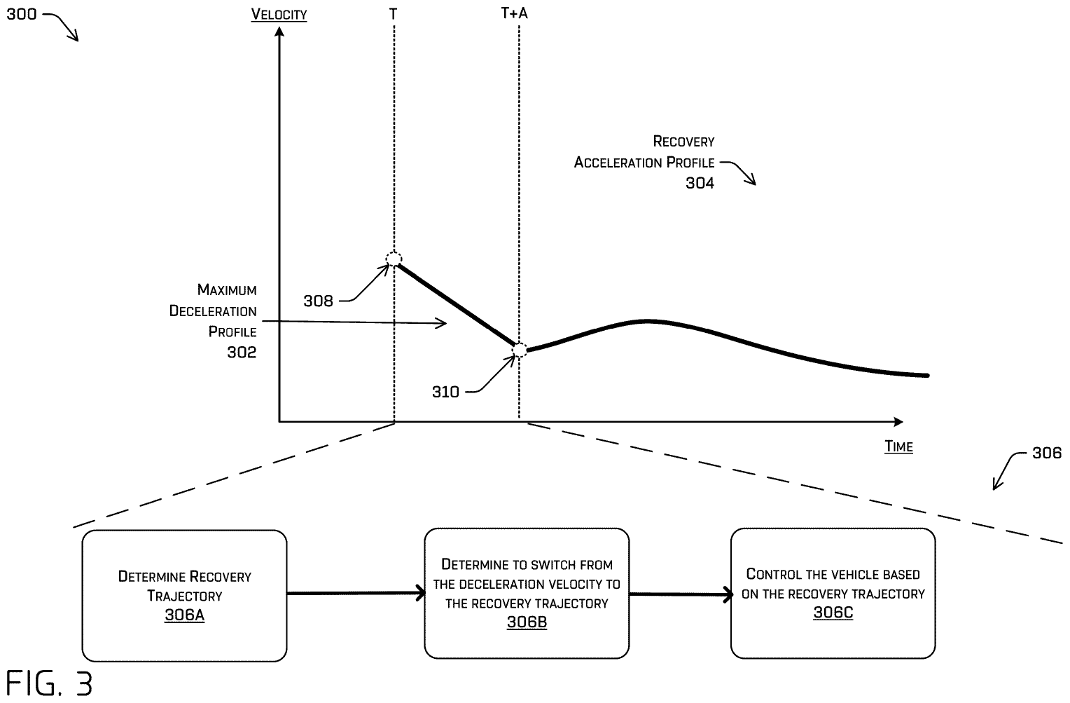

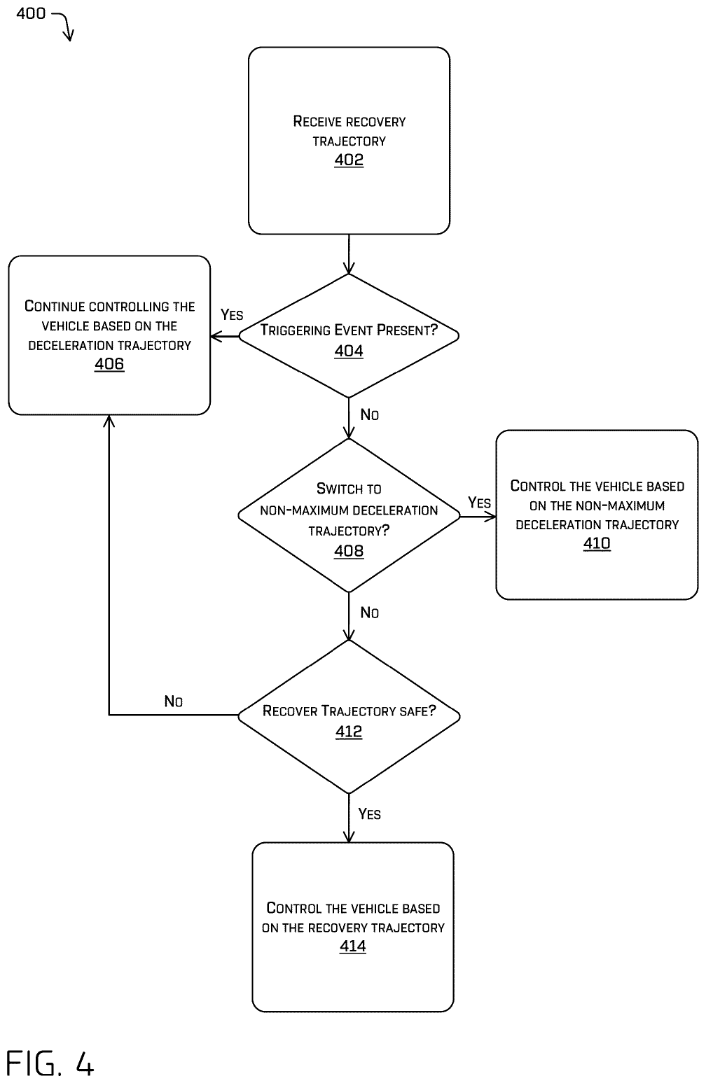

After the recovery trajectory is determined, the system determines whether to switch from the maximum deceleration trajectory to the recovery trajectory. Example techniques for determining whether to switch to the recovery trajectory are described below with reference to FIGS. 3-4.

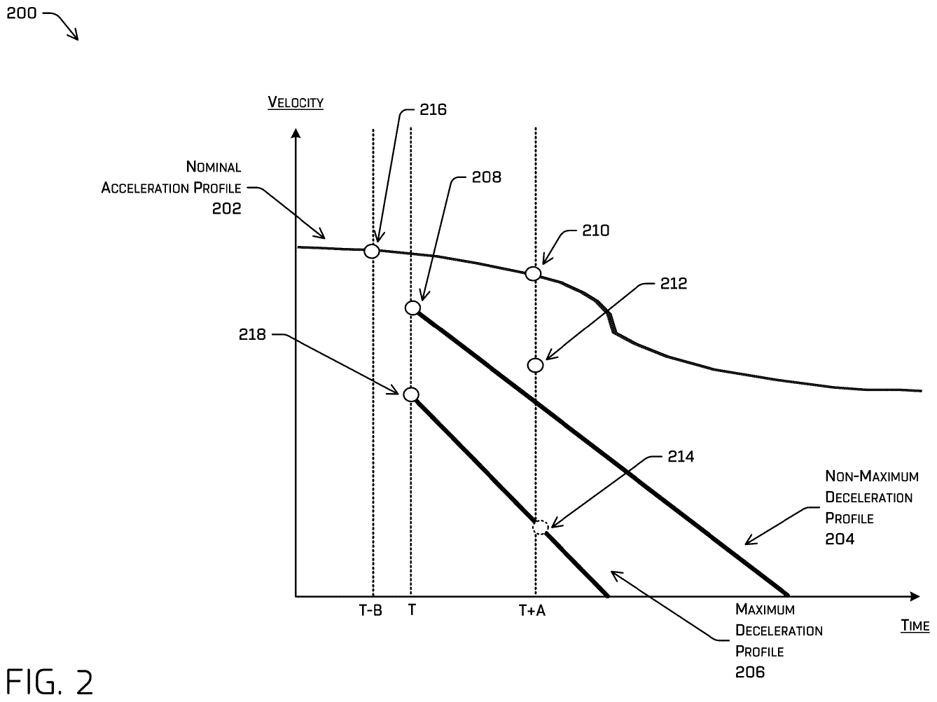

FIG. 2 provides an operational example 200 of three longitudinal acceleration profiles. Specifically, the operational example 200 includes: (i) a nominal acceleration profile 202, (ii) a non-maximum deceleration profile 204, and (iii) a maximum deceleration profile 206. For example, based on determining an safety condition at time T, the system may determine whether to switch to the non-maximum deceleration profile 204 or the maximum deceleration profile 206. In some cases, T and T+A may be times associated with determining a trajectory for controlling the vehicle (e.g., two different trajectory determination iterations). For example, A may be associated with an interval between two trajectory determination iterations (e.g., two iterations of a system, such as a primary system, configured to determine a trajectory for a vehicle).

In some cases, at a time T−B, the system (e.g., a secondary system, for example as described above) may determine (e.g., based on detecting a failure event) to switch from a nominal trajectory associated with the nominal acceleration profile 202 to at least one of a non-maximum deceleration trajectory associated with the non-maximum deceleration profile 204 or a maximum deceleration trajectory associated with the maximum deceleration profile 206. In some cases, T−B may be a time after T−A (e.g., B may be a time less than A, which may be an interval between two trajectory determination operations). Example techniques for determining whether to switch out of a nominal trajectory and/or for selecting between a maximum deceleration trajectory and a non-maximum deceleration trajectory are described above.

The nominal trajectory may be associated with the velocity 216 at time T−B. In some cases, if the system determines to switch from the nominal trajectory to the non-maximum deceleration trajectory at time T−B, the vehicle may have a velocity 208 at time T. In some cases, if the system determines to switch from the nominal trajectory to the maximum deceleration trajectory at time T−B, the vehicle may have a velocity 218 at time T. This may be because the maximum deceleration trajectory is associated with a higher-magnitude deceleration relative to the magnitude of the deceleration associated with the non-maximum deceleration trajectory.

As further depicted in FIG. 2, at time T+A, the nominal acceleration profile 202 may be associated with the velocity 210 at time T−B. For example, the nominal trajectory may require having the velocity 210 at the time T−B. However, detection of a failure event may cause transitioning into one of the non-maximum deceleration profile 204 or the maximum deceleration profile 206.

The non-maximum deceleration profile 204 may cause decelerating to reduce the velocity from the velocity 208 to the velocity 212 at time T. For example, velocity 212 may result from applying a non-maximum acceleration at time T−B.

The maximum deceleration profile 206 may require applying a maximum deceleration (e.g., a deceleration higher than the deceleration associated with the non-maximum deceleration profile 204). This may be predicted to cause the velocity to reduce from the velocity 208 to the predicted velocity 214 at time T+A. In some cases, if the maximum deceleration profile 206 is adopted at time T−B, the velocity associated with time T+A is predicted based on the maximum deceleration rate associated with the vehicle (e.g., as determined based on a fixed value, as determined based on vehicle condition(s) and/or vehicle environment condition(s), and/or the like).

FIG. 3 provides an operational example 300 of determining whether to control a vehicle based on a recovery trajectory. As depicted in FIG. 3, the recovery trajectory is associated with a recovery acceleration profile 304, which may be the longitudinal acceleration profile for that recovery trajectory. The recovery acceleration profile 304 may include a predicted velocity 310 associated with the time T+A. The predicted velocity 310 may be determined based on a measured velocity 308 at a time T as well as a maximum deceleration profile 302 associated with a period including T and T+A.

The time T may, for example, be a time associated with detecting an safety condition and/or activating a maximum deceleration trajectory. The time T+A may, for example, be a time after the time T, where the delay period between T and T+A may include: (i) an expected time for determining whether to transition out of (e.g., release) the maximum deceleration trajectory, and (ii) an expected time for determining whether to transition into (e.g., switch to) the recovery trajectory. In some cases, the trajectory used to control a vehicle is determined iteratively (e.g., periodically, such as every five milliseconds). In these cases, the time T may be a time associated with a first iteration that begins after detecting an safety condition. Moreover, the time T+A may be associated with a delay period after T, where this delay period may include: (i) an expected time for determining a recovery trajectory, (ii) an expected time for determining whether to transition out of (e.g., release) the maximum deceleration trajectory, (iii) an expected time for determining whether to transition into (e.g., switch to) the recovery trajectory, (iv) an expected time associated with one or more expected system latencies, (v) an expected time for causing the vehicle (e.g., one or more vehicle actuators) to be controlled based on the recovery trajectory, and/or (vi) an expected time for starting a new trajectory determination iteration after determining whether to transition out of the maximum deceleration trajectory and/or whether to transition into the recovery trajectory.

In some cases, during the period including (e.g., in between) T and T+A, an example system determines whether to switch from the maximum deceleration trajectory into the generated recovery trajectory. The system may, for example, make such a determination based on the process 306. As depicted in accordance with the process 306, at operation 306A, the system (e.g., a primary system, for example as described above) determines the recovery trajectory. The recovery trajectory may, for example, be associated with a longitudinal acceleration profile determined based on a predicted velocity at a subsequent time T+A and a lateral motion profile of a preceding nominal trajectory. Example techniques for determining recovery trajectories for transitioning out of maximum deceleration trajectories are described above.

At operation 306B, the system (e.g., a secondary system, for example as described above) determines to switch from the maximum deceleration trajectory to the recovery trajectory. Determining to switch the maximum deceleration trajectory to the recovery trajectory may include: (i) determining to transition out of the maximum deceleration trajectory, and (ii) determining to transition into the maximum deceleration trajectory. Example techniques for determining whether to switch from the maximum deceleration trajectory to the recovery trajectory are described above and/or below with reference to FIG. 4.

In some cases, the system determines whether to switch from the maximum deceleration trajectory to the recovery trajectory based on: (i) whether the safety condition (e.g., safety event, such as a failure) that initially triggered transitioning into the maximum deceleration trajectory still exists, (ii) whether a safety score associated with the recovery trajectory exceeds a threshold, and/or (iii) whether transitioning into a non-maximum deceleration trajectory is warranted. For example, the system may determine to switch from the maximum deceleration trajectory to the recovery trajectory if: (i) the safety condition no longer exists, (ii) the safety score associated with the recovery trajectory exceeds the threshold, and (iii) transitioning into a non-maximum deceleration trajectory is not warranted. In some cases, the system determines whether the safety condition still exists based on determining whether an imminent failure likelihood exceeds a threshold. The system may determine the safety score associated with the recovery trajectory based on one or more of: (i) a deviation between a predicted velocity at a subsequent time and a measured velocity at the subsequent time, or (ii) a deviation between a predicted position at the subsequent time and a measured position at the subsequent time. The system may determine whether transitioning into a non-maximum deceleration trajectory is warranted based on determining whether a non-imminent failure likelihood exceeds a threshold.

At operation 306C, the system controls the vehicle based on the recovery trajectory based on determining to switch from the maximum deceleration trajectory to the recovery trajectory. Controlling a vehicle based on a trajectory may include controlling and/or actuating movement(s) of a vehicle in accordance with one or more lateral movements described by the trajectory's lateral motion profile and/or one or more longitudinal acceleration actions described by the trajectory's longitudinal acceleration profile. Accordingly, the system may control and/or actuate vehicle movements one or more lateral movements described by the recovery trajectory's lateral motion profile and/or one or more longitudinal acceleration actions described by the recovery trajectory's longitudinal acceleration profile.

FIG. 4 is a flowchart diagram of an example process 400 for conditionally controlling a vehicle based on a recovery trajectory. As depicted in FIG. 4, at operation 402, an example system receives a recovery trajectory. The recovery trajectory may, for example, be associated with a longitudinal acceleration profile determined based on a predicted velocity at a subsequent time and a lateral motion profile of a preceding nominal trajectory. Example techniques for determining a recovery trajectory are described above.

At operation 404, the system determines whether a triggering event is present. The triggering event may be a condition that initially caused the system to transition into a maximum deceleration trajectory. If the triggering event is present (operation 404—Yes), the process 400 proceeds to operation 406, where the system continues controlling the vehicle based on the maximum deceleration trajectory.

However, if the triggering event is not present (operation 404—No), the process proceeds to operation 408, where the system determines whether to switch to a non-maximum deceleration trajectory. Switching to a non-maximum deceleration trajectory may be based on determining whether an imminent failure probability associated with the vehicle's operation is above a threshold associated with switching into a nominal trajectory. The non-maximum deceleration trajectory may be associated with a non-maximum deceleration. This non-maximum deceleration may be lower than a maximum deceleration associated with the maximum deceleration trajectory. Example techniques for selecting between a maximum deceleration trajectory and a non-maximum deceleration trajectory are provided above.

If the system determines to switch to the non-maximum deceleration trajectory (operation 408—Yes), the process proceeds to operation 410, where the vehicle is controlled based on the second deceleration trajectory. If the system determines not to switch to the second deceleration trajectory (operation 408—No), the process proceeds to operation 412

At operation 412, the system determines whether the recovery trajectory is safe. Determining whether the recovery trajectory is safe may be based on a safety score computed for the recovery trajectory. In some cases, the safety score is determined based on: (i) a deviation between a predicted velocity used to determine the recovery trajectory and a measured velocity for the same time, and/or (ii) a deviation between a predicted position used to determine the recovery trajectory and a measured position for the same time. Example techniques for determining a safety score for a recovery trajectory are described above.

If the recovery trajectory is not determined to be safe, (operation 412—No) the process returns to operation 406, where the system continues controlling the vehicle based on the maximum deceleration trajectory. If the recovery trajectory is determined to be safe (operation 408—Yes), the process proceeds to operation 414 to control the vehicle based on the recovery trajectory.

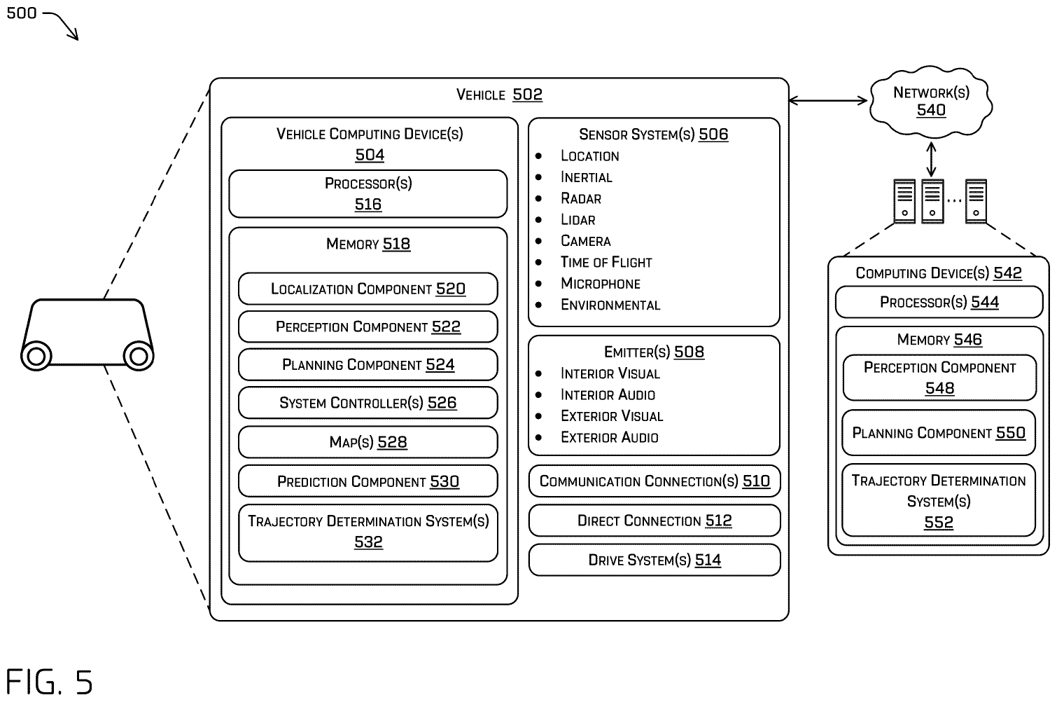

FIG. 5 depicts a block diagram of an example system 500 for implementing the techniques described herein. In at least one example, the system 500 can include a vehicle 502. The vehicle 502 can include a vehicle computing system or device 504 that may function as and/or perform the functions of a vehicle controller for the vehicle 502. The vehicle 502 can also include one or more sensor systems 506, one or more emitters 508, one or more communication connections 510, at least one direct connection 512, and one or more drive systems 514.

The vehicle computing device 504 can include one or more processors 516 and memory 518 communicatively coupled with the one or more processors 516. In the illustrated example, the vehicle 502 is an autonomous vehicle; however, the vehicle 502 could be any other type of vehicle. In the illustrated example, the memory 518 of the vehicle computing device 504 stores a localization component 520, a perception component 522, a planning component 524, one or more system controllers 526, one or more maps 528, a prediction component 530, and one or more trajectory determination systems 532. Though depicted in FIG. 5 as residing in memory 518 for illustrative purposes, it is contemplated that each of the localization component 520, the perception component 522, the planning component 524, the one or more system controllers 526, the one or more maps 528, the prediction component 530, and the trajectory determination system(s) 532 can additionally, or alternatively, be accessible to the vehicle 502 (e.g., stored remotely). Alternatively or additionally, the trajectory determination system(s) 532 may be a component of and/or associated with a remote computing device and/or a separate (e.g., secondary) computing device. Examples of systems and methods for using a secondary computing device as trajectory determination system are provided in U.S. patent application Ser. No. 17/514,542, filed Oct. 29, 2021, entitled “Collision Avoidance and Mitigation in Autonomous Vehicles,” which is incorporated herein by reference in its entirety and for all purposes.

In at least one example, the localization component 520 can include functionality to receive data from the sensor system(s) 506 to determine a position and/or orientation of the vehicle 502 (e.g., one or more of an x-, y-, z-position, roll, pitch, or yaw). For example, the localization component 520 can include and/or request/receive a map of an environment and can continuously determine a location and/or orientation of the autonomous vehicle within the map. In some instances, the localization component 520 can utilize SLAM (simultaneous localization and mapping), CLAMS (calibration, localization and mapping, simultaneously), relative SLAM, bundle adjustment, non-linear least squares optimization, or the like to receive image data, LIDAR data, radar data, IMU data, GPS data, wheel encoder data, and the like to accurately determine a location of the autonomous vehicle. In some instances, the localization component 520 can provide data to various components of the vehicle 502 to determine an initial position of an autonomous vehicle for generating a trajectory and/or for generating map data, as discussed herein.

In some instances, the perception component 522 can include functionality to perform object detection, segmentation, and/or classification. In some examples, the perception component 522 can provide processed sensor data that indicates a presence of an entity that is proximate to the vehicle 502 and/or a classification of the entity as an entity type (e.g., car, pedestrian, cyclist, animal, building, tree, road surface, curb, sidewalk, traffic signal, traffic light, car light, brake light, unknown, etc.). In additional or alternative examples, the perception component 522 can provide processed sensor data that indicates one or more characteristics associated with a detected entity (e.g., a tracked object) and/or the environment in which the entity is positioned. The perception component 522 may use the multichannel data structures as described herein, such as the multichannel data structures generated by the described deconvolution process, to generate processed sensor data. In some examples, characteristics associated with an entity or object can include, but are not limited to, an x-position (global and/or local position), a y-position (global and/or local position), a z-position (global and/or local position), an orientation (e.g., a roll, pitch, yaw), an entity type (e.g., a classification), a velocity of the entity, an acceleration of the entity, an extent of the entity (size), etc. Such entity characteristics may be represented in a multichannel data structure as described herein (e.g., a multichannel data structure generated as output of one or more deconvolution layers (e.g., learned deconvolutional upsampling decoding layer(s)) using a learned upsampling transformation). Characteristics associated with the environment can include, but are not limited to, a presence of another entity in the environment, a state of another entity in the environment, a time of day, a day of a week, a season, a weather condition, an indication of darkness/light, etc.

In general, the planning component 524 can determine a path for the vehicle 502 to follow to traverse through an environment. In examples, the planning component 524 can determine various routes and trajectories and various levels of detail. For example, the planning component 524 can determine a route (e.g., planned route) to travel from a first location (e.g., a current location) to a second location (e.g., a target location). For the purpose of this discussion, a route can be a sequence of waypoints for travelling between two locations. As non-limiting examples, waypoints include streets, intersections, global positioning system (GPS) coordinates, etc. Further, the planning component 524 can generate an instruction for guiding the autonomous vehicle along at least a portion of the route from the first location to the second location. In at least one example, the planning component 524 can determine how to guide the autonomous vehicle from a first waypoint in the sequence of waypoints to a second waypoint in the sequence of waypoints. In some examples, the instruction can be a trajectory, or a portion of a trajectory. In some examples, multiple trajectories can be substantially simultaneously generated (e.g., within technical tolerances) in accordance with a receding horizon technique, wherein one of the multiple trajectories is selected for the vehicle 502 to navigate.

In at least one example, the vehicle computing device 504 can include one or more system controllers 526, which can be configured to control steering, propulsion, braking, safety, emitters, communication, and other systems of the vehicle 502. These system controller(s) 526 can communicate with and/or control corresponding systems of the drive system(s) 514 and/or other components of the vehicle 502.

The memory 518 can further include one or more maps 528 that can be used by the vehicle 502 to navigate within the environment. For the purpose of this discussion, a map can be any number of data structures modeled in two dimensions, three dimensions, or N-dimensions that are capable of providing information about an environment, such as, but not limited to, topologies (such as intersections), streets, mountain ranges, roads, terrain, and the environment in general. In some instances, a map can include, but is not limited to: texture information (e.g., color information (e.g., RGB color information, Lab color information, HSV/HSL color information), non-visible light information (near-infrared light information, infrared light information, and the like), intensity information (e.g., lidar information, radar information, near-infrared light intensity information, infrared light intensity information, and the like); spatial information (e.g., image data projected onto a mesh, individual “surfels” (e.g., polygons associated with individual color and/or intensity)); and reflectivity information (e.g., specularity information, retroreflectivity information, BRDF information, BSSRDF information, and the like). In an example, a map can include a three-dimensional mesh of the environment. In some instances, the map can be stored in a tiled format, such that individual tiles of the map represent a discrete portion of an environment, and can be loaded into working memory as needed, as discussed herein. In at least one example, the one or more maps 528 can include at least one map (e.g., images and/or a mesh). In some examples, the vehicle 502 can be controlled based at least in part on the maps 528. That is, the maps 528 can be used in connection with the localization component 520, the perception component 522, and/or the planning component 524 to determine a location of the vehicle 502, identify objects in an environment, and/or generate routes and/or trajectories to navigate within an environment.

In some examples, the one or more maps 528 can be stored on a remote computing device(s) (such as the computing device(s) 542) accessible via network(s) 540. In some examples, multiple maps 528 can be stored based on, for example, a characteristic (e.g., type of entity, time of day, day of week, season of the year, etc.). Storing multiple maps 528 can have similar memory requirements but increase the speed at which data in a map can be accessed.

In general, the prediction component 530 can generate predicted trajectories of objects in an environment. For example, the prediction component 530 can generate one or more predicted trajectories for vehicles, pedestrians, animals, and the like within a threshold distance from the vehicle 502. In some instances, the prediction component 530 can measure a trace of an object and generate a trajectory for the object based on observed and predicted behavior.

In some instances, aspects of some or all of the components discussed herein can include any models, algorithms, and/or machine learning algorithms. For example, in some instances, the components in the memory 518 (and the memory 546, discussed below) can be implemented as a neural network. For instance, the memory 518 may include a deep tracking network that may be configured with a convolutional neural network (CNN). The CNN may include one or more convolution/deconvolution layers. Alternatively, or in addition, the one or more trajectory determination systems 532 may include a CNN that may perform operations as described herein.

An example neural network is an algorithm that passes input data through a series of connected layers to produce an output. Each layer in a neural network can also comprise another neural network or can comprise any number of layers, each of which may convolutional, deconvolutional, or another type of layer. As can be understood in the context of this disclosure, a neural network can utilize machine learning, which can refer to a broad class of such algorithms in which an output is generated based on learned parameters.

Although discussed in the context of neural networks, any type of machine learning can be used consistent with this disclosure, for example, to determine a braking trajectory. For example, machine learning algorithms can include, but are not limited to, regression algorithms (e.g., ordinary least squares regression (OLSR), linear regression, logistic regression, stepwise regression, multivariate adaptive regression splines (MARS), locally estimated scatterplot smoothing (LOESS)), instance-based algorithms (e.g., ridge regression, least absolute shrinkage and selection operator (LASSO), elastic net, least-angle regression (LARS)), decisions tree algorithms (e.g., classification and regression tree (CART), iterative dichotomiser 3 (ID3), Chi-squared automatic interaction detection (CHAID), decision stump, conditional decision trees), Bayesian algorithms (e.g., naïve Bayes, Gaussian naïve Bayes, multinomial naïve Bayes, average one-dependence estimators (AODE), Bayesian belief network (BNN), Bayesian networks), clustering algorithms (e.g., k-means, k-medians, expectation maximization (EM), hierarchical clustering), association rule learning algorithms (e.g., perceptron, back-propagation, hopfield network, Radial Basis Function Network (RBFN)), deep learning algorithms (e.g., Deep Boltzmann Machine (DBM), Deep Belief Networks (DBN), Convolutional Neural Network (CNN), Stacked Auto-Encoders), Dimensionality Reduction Algorithms (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Algorithms (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc. Additional examples of architectures include neural networks such as ResNet50, ResNet101, VGG, DenseNet, PointNet, and the like.

In at least one example, the sensor system(s) 506 can include radar sensors, ultrasonic transducers, sonar sensors, location sensors (e.g., GPS, compass, etc.), inertial sensors (e.g., inertial measurement units (IMUs), accelerometers, magnetometers, gyroscopes, etc.), cameras (e.g., RGB, IR, intensity, depth, etc.), time of flight sensors, audio sensors, acoustic sensors, microphones, wheel encoders, environment sensors (e.g., temperature sensors, humidity sensors, light sensors, pressure sensors, etc.), etc. The sensor system(s) 506 can include multiple instances of each of these or other types of sensors. For instance, the camera sensors can include multiple cameras disposed at various locations about the exterior and/or interior of the vehicle 502. The sensor system(s) 506 can provide input to the vehicle computing device 504. Additionally, or alternatively, the sensor system(s) 506 can send sensor data, via the one or more networks 540, to the one or more computing device(s) at a particular frequency, after a lapse of a predetermined period of time, in near real-time, etc.

The vehicle 502 can also include one or more emitters 508 for emitting light (visible and/or non-visible) and/or sound. The emitter(s) 508 in an example include interior audio and visual emitters to communicate with passengers of the vehicle 502. By way of example and not limitation, interior emitters can include speakers, lights, signs, display screens, touch screens, haptic emitters (e.g., vibration and/or force feedback), mechanical actuators (e.g., seatbelt tensioners, seat positioners, headrest positioners, etc.), and the like. The emitter(s) 508 in this example may also include exterior emitters. By way of example and not limitation, the exterior emitters in this example include lights to signal a direction of travel or other indicator of vehicle action (e.g., indicator lights, signs, light arrays, etc.), and one or more audio emitters (e.g., speakers, speaker arrays, horns, etc.) to audibly communicate with pedestrians or other nearby vehicles, one or more of which comprising acoustic beam steering technology. The exterior emitters in this example may also, or instead, include non-visible light emitters such as infrared emitters, near-infrared emitters, and/or lidar emitters.

The vehicle 502 can also include one or more communication connection(s) 510 that enable communication between the vehicle 502 and one or more other local or remote computing device(s). For instance, the communication connection(s) 510 can facilitate communication with other local computing device(s) on the vehicle 502 and/or the drive system(s) 514. Also, the communication connection(s) 510 can allow the vehicle to communicate with other nearby computing device(s) (e.g., other nearby vehicles, traffic signals, etc.). The communications connection(s) 510 also enable the vehicle 502 to communicate with a remote teleoperations computing device or other remote services.

The communications connection(s) 510 can include physical and/or logical interfaces for connecting the vehicle computing device 504 to another computing device or a network, such as network(s) 540. For example, the communications connection(s) 510 can enable Wi-Fi-based communication such as via frequencies defined by the IEEE 802.11 standards, short range wireless frequencies such as Bluetooth, cellular communication (e.g., 2G, 3G, 4G, 4G LTE, 5G, etc.) or any suitable wired or wireless communications protocol that enables the respective computing device to interface with the other computing device(s).

In at least one example, the vehicle 502 can include one or more drive systems 514. In some examples, the vehicle 502 can have a single drive system 514. In at least one example, if the vehicle 502 has multiple drive systems 514, individual drive systems 514 can be positioned on opposite ends of the vehicle 502 (e.g., the front and the rear, etc.). In at least one example, the drive system(s) 514 can include one or more sensor systems to detect conditions of the drive system(s) 514 and/or the surroundings of the vehicle 502. By way of example and not limitation, the sensor system(s) 506 can include one or more wheel encoders (e.g., rotary encoders) to sense rotation of the wheels of the drive systems, inertial sensors (e.g., inertial measurement units, accelerometers, gyroscopes, magnetometers, etc.) to measure orientation and acceleration of the drive system, cameras or other image sensors, ultrasonic sensors to acoustically detect objects in the surroundings of the drive system, lidar sensors, radar sensors, etc. Some sensors, such as the wheel encoders can be unique to the drive system(s) 514. In some cases, the sensor system(s) on the drive system(s) 514 can overlap or supplement corresponding systems of the vehicle 502 (e.g., sensor system(s) 506).

The drive system(s) 514 can include many of the vehicle systems, including a high voltage battery, a motor to propel the vehicle, an inverter to convert direct current from the battery into alternating current for use by other vehicle systems, a steering system including a steering motor and steering rack (which can be electric), a braking system including hydraulic or electric actuators, a suspension system including hydraulic and/or pneumatic components, a stability control system for distributing brake forces to mitigate loss of traction and maintain control, an HVAC system, lighting (e.g., lighting such as head/tail lights to illuminate an exterior surrounding of the vehicle), and one or more other systems (e.g., cooling system, safety systems, onboard charging system, other electrical components such as a DC/DC converter, a high voltage junction, a high voltage cable, charging system, charge port, etc.). Additionally, the drive system(s) 514 can include a drive system controller which can receive and preprocess data from the sensor system(s) and to control operation of the various vehicle systems. In some examples, the drive system controller can include one or more processors and memory communicatively coupled with the one or more processors. The memory can store one or more components to perform various functionalities of the drive system(s) 514. Furthermore, the drive system(s) 514 may also include one or more communication connection(s) that enable communication by the respective drive system with one or more other local or remote computing device(s).

In at least one example, the direct connection 512 can provide a physical interface to couple the one or more drive system(s) 514 with the body of the vehicle 502. For example, the direct connection 512 can allow the transfer of energy, fluids, air, data, etc. between the drive system(s) 514 and the vehicle. In some instances, the direct connection 512 can further releasably secure the drive system(s) 514 to the body of the vehicle 502.

In some examples, the vehicle 502 can send sensor data, audio data, failure data, and/or other types of data to one or more computing device(s) 542 via the network(s) 540. In some examples, the vehicle 502 can send raw sensor data to the computing device(s) 542. In other examples, the vehicle 502 can send processed sensor data and/or representations of sensor data (e.g., multichannel data structures representing sensor data) to the computing device(s) 542. In some examples, the vehicle 502 can send sensor data to the computing device(s) 542 at a particular frequency, after a lapse of a predetermined period of time, in near real-time, etc. In some cases, the vehicle 502 can send sensor data (raw or processed) to the computing device(s) 542 as one or more log files.

The computing device(s) 542 can include processor(s) 544 and a memory 546 storing one or more perception components 548, planning components 550, and/or one or more trajectory determination systems 552. In some instances, the one or more trajectory determination systems 552 can substantially correspond the one or more trajectory determination systems 532 and can include substantially similar functionality. In some instances, the perception component 548 can substantially correspond to the perception component 522 and can include substantially similar functionality. In some instances, the planning component 550 can substantially correspond to the planning component 524 and can include substantially similar functionality.

The processor(s) 516 of the vehicle 502 and the processor(s) 544 of the computing device(s) 542 can be any suitable processor capable of executing computer-executable instructions to process data and perform operations as described herein. By way of example and not limitation, the processor(s) 516 and 544 can comprise one or more Central Processing Units (CPUs), Graphics Processing Units (GPUs), and/or any other device or portion of a device that processes electronic data to transform that electronic data into other electronic data that can be stored in registers and/or memory. In some examples, integrated circuits (e.g., ASICs, etc.), gate arrays (e.g., FPGAs, etc.), and other hardware devices can also be considered processors in so far as they are configured to implement encoded instructions.

Memory 518 and 546 are examples of non-transitory computer-readable media. The memory 518 and 546 can store an operating system and one or more software applications, instructions, programs, and/or data to implement the methods described herein and the functions attributed to the various systems. In various implementations, the memory can be implemented using any suitable memory technology, such as static random-access memory (SRAM), synchronous dynamic RAM (SDRAM), nonvolatile/Flash-type memory, or any other type of memory capable of storing information. The architectures, systems, and individual elements described herein can include many other logical, programmatic, and physical components, of which those shown in the accompanying figures are merely examples that are related to the discussion herein.

It should be noted that while FIG. 5 is illustrated as a distributed system, in alternative examples, components of the vehicle 502 can be associated with the computing device(s) 542 and/or components of the computing device(s) 542 can be associated with the vehicle 502. That is, the vehicle 502 can perform one or more of the functions associated with the computing device(s) 542, and vice versa.

### EXAMPLE CLAUSES

The following paragraphs describe various examples. Any of the examples in this section may be used with any other of the examples in this section and/or any of the other examples or embodiments described herein.
A: A system comprising: one or more processors; and one or more non-transitory computer-readable media storing computer-executable instructions that, when executed, cause the system to perform operations comprising: receiving first data representing that a vehicle is being controlled based at least in part on a first trajectory, wherein the first trajectory is associated with a lateral motion profile in a lateral direction and an acceleration profile in a longitudinal direction normal to the lateral direction; causing the vehicle to apply a maximum deceleration, a first magnitude of the maximum deceleration being greater than a second magnitude of a first lower-bound deceleration associated with determining the acceleration profile and greater than a third magnitude of deceleration associated with a non-maximum braking; receiving second data representing a measured velocity associated with the vehicle at a first time; determining, based at least in part on the measured velocity and the maximum deceleration, a predicted velocity associated with the vehicle at a second time after the first time; determining, based at least in part on the lateral motion profile and the predicted velocity, a second trajectory; determining third data representing whether to control the vehicle based at least in part on the second trajectory; and controlling the vehicle based at least in part on the third data.
B: The system of paragraph A, wherein: the first trajectory and the second trajectory are generated by a first system, and causing the vehicle to apply the maximum deceleration is based on determining, by a second system, that the first trajectory is expected to lead to failure.
C: The system of paragraph A or B, wherein causing the vehicle to apply the maximum deceleration comprises: detecting an event associated with at least one of the vehicle or an environment of the vehicle; and determining that the non-maximum braking is insufficient for responding to the event.
D: The system of any of paragraphs A-C, wherein determining the third data is based on at least one of: a first deviation associated with a predicted longitudinal position associated with the second time and a measured longitudinal position associated with the second time, a second deviation associated with the predicted velocity and a second measured velocity associated with the second time, presence or absence of an event associated with causing the vehicle to apply the maximum deceleration; presence of absence of a second event associated with triggering the maximum deceleration; whether to control the vehicle based on the non-maximum braking; or a score associated with the second trajectory.
E: The system of any of paragraphs A-D, wherein the second trajectory comprises following the lateral motion profile.
F: One or more non-transitory computer-readable media storing instructions executable by one or more processors, wherein the instructions, when executed, cause the one or more processors to perform operations comprising: receiving first data representing that a vehicle is being controlled based at least in part on a first trajectory determined in accordance with a nominal acceleration limit, wherein the first trajectory is associated with a lateral motion profile; causing the vehicle to apply a maximum deceleration, a first magnitude of the maximum deceleration being greater than the nominal acceleration limit and a second magnitude of a second deceleration associated with a safety trajectory associated with responding to an event; receiving second data representing a measured velocity associated with the vehicle at a first time; determining, based at least in part on the measured velocity and the maximum deceleration, a predicted velocity associated with the vehicle at a second time after the first time; determining, based at least in part on the lateral motion profile and the predicted velocity, a second trajectory for returning the vehicle to nominal operations; determining third data representing whether to control the vehicle based at least in part on the second trajectory; and controlling the vehicle based at least in part on the third data.
G: The one or more non-transitory computer-readable media of paragraph F, wherein: the first trajectory is associated with at least one of decelerating or accelerating within the nominal acceleration limit, the second deceleration is associated with decelerating based on a lower-bound deceleration defined by the nominal acceleration limit, and the maximum deceleration is associated with decelerating more than the lower-bound deceleration.
H: The one or more non-transitory computer-readable media of paragraph F or G, wherein determining the second trajectory comprises determining a predicted longitudinal position associated with the second time.
I: The one or more non-transitory computer-readable media of paragraph H, wherein determining the predicted longitudinal position is based on a measured longitudinal position associated with the first time, the measured velocity associated with the first time, and the predicted velocity associated with the second time.
J: The one or more non-transitory computer-readable media of any of paragraphs F-I, wherein controlling the vehicle comprises, based on determining to refrain from controlling the vehicle based on the second trajectory, continuing to control the vehicle based on the maximum deceleration.
K: The one or more non-transitory computer-readable media of paragraph J, wherein determining to refrain from controlling the vehicle based on the second trajectory is based on at least one of: a failure likelihood associated with at least one of the vehicle or an environment of the vehicle, a failure severity associated with at least one of the vehicle or the environment, or whether a time associated with determining whether to refrain from controlling the vehicle based on the second trajectory is within a period after detecting the event.
L: The one or more non-transitory computer-readable media of paragraph J or K, wherein determining to refrain from controlling the vehicle based on the second trajectory comprises making a determination within a time limit.
M: The one or more non-transitory computer-readable media of any of paragraphs F-L, the operations further comprising determining the first magnitude.
N: The one or more non-transitory computer-readable media of paragraph M, wherein determining the first magnitude is based on at least one of: a road incline, a road surface type, a road condition, a weather condition, a wind condition, an air density, an air temperature, an air pressure, an engine temperature, a vehicle altitude, a tire condition, a weight associated with the vehicle, a vehicle fuel quality, availability of regenerative braking, a condition associated with a brake system of the vehicle, or a condition associated with a suspension control of the vehicle.
O: The one or more non-transitory computer-readable media of any of paragraphs F-N, wherein the second trajectory comprises following the lateral motion profile and being at a predicted longitudinal position associated with the second time.
P: A method comprising: receiving first data representing that a vehicle is being controlled based at least in part on a first trajectory determined in accordance with a nominal acceleration limit, wherein the first trajectory is associated with a lateral motion profile; causing the vehicle to apply a maximum deceleration, a first magnitude of the maximum deceleration being greater than the nominal acceleration limit and a second magnitude of a second deceleration associated with a safety trajectory associated with responding to an event; receiving second data representing a measured velocity associated with the vehicle at a first time; determining, based at least in part on the measured velocity and the maximum deceleration, a predicted velocity associated with the vehicle at a second time after the first time; determining, based at least in part on the lateral motion profile and the predicted velocity, a second trajectory for returning the vehicle to nominal operations; determining third data representing whether to control the vehicle based at least in part on the second trajectory; and controlling the vehicle based at least in part on the third data.
Q: The method of paragraph P, wherein: the first trajectory is associated with at least one of decelerating or accelerating within the nominal acceleration limit, the second deceleration is associated with decelerating based on a lower-bound deceleration defined by the nominal acceleration limit, and the maximum deceleration is associated with decelerating more than the lower-bound deceleration.
R: The method of paragraph P or Q, wherein determining the second trajectory comprises determining a predicted longitudinal position associated with the second time.
S: The method of paragraph R, wherein determining the predicted longitudinal position is based on a measured longitudinal position associated with the first time, the measured velocity associated with the first time, and the predicted velocity associated with the second time.
T: The method of any of paragraphs P-S, wherein controlling the vehicle comprises, based on determining to refrain from controlling the vehicle based on the second trajectory, continuing to control the vehicle based on the maximum deceleration.

While the example clauses described above are described with respect to one particular implementation, it should be understood that, in the context of this document, the content of the example clauses can also be implemented via a method, device, system, computer-readable medium, and/or another implementation. Additionally, any of examples A-5 can be implemented alone or in combination with any other one or more of the examples A-T.

### CONCLUSION

While one or more examples of the techniques described herein have been described, various alterations, additions, permutations, and equivalents thereof are included within the scope of the techniques described herein.

What is claimed is:

1. A system comprising:
one or more processors; and
one or more non-transitory computer-readable media storing computer-executable instructions that, when executed, cause the system to perform operations comprising:
receiving first data representing that a vehicle is being controlled based at least in part on a first trajectory, wherein the first trajectory is associated with a lateral motion profile in a lateral direction and an acceleration profile in a longitudinal direction normal to the lateral direction;
causing the vehicle to apply a maximum deceleration, a first magnitude of the maximum deceleration being greater than a second magnitude of a first lower-bound deceleration associated with determining the acceleration profile and greater than a third magnitude of deceleration associated with a non-maximum braking;
receiving second data representing a measured velocity associated with the vehicle at a first time;
determining, based at least in part on the measured velocity and the maximum deceleration, a predicted velocity associated with the vehicle at a second time after the first time;
determining, based at least in part on the lateral motion profile and the predicted velocity, a second trajectory;
determining third data representing whether to control the vehicle based at least in part on the second trajectory; and
controlling the vehicle based at least in part on the third data.

2. The system of claim 1, wherein:
the first trajectory and the second trajectory are generated by a first system, and
causing the vehicle to apply the maximum deceleration is based on determining, by a second system, that the first trajectory is expected to lead to failure.

3. The system of claim 1, wherein causing the vehicle to apply the maximum deceleration comprises:
detecting an event associated with at least one of the vehicle or an environment of the vehicle; and
determining that the non-maximum braking is insufficient for responding to the event.

4. The system of claim 1, wherein determining the third data is based on at least one of:
a first deviation associated with a predicted longitudinal position associated with the second time and a measured longitudinal position associated with the second time,
a second deviation associated with the predicted velocity and a second measured velocity associated with the second time,
presence or absence of an event associated with causing the vehicle to apply the maximum deceleration;
presence of absence of a second event associated with triggering the maximum deceleration;
whether to control the vehicle based on the non-maximum braking; or
a score associated with the second trajectory.

5. The system of claim 1, wherein the second trajectory comprises following the lateral motion profile.

6. One or more non-transitory computer-readable media storing instructions executable by one or more processors, wherein the instructions, when executed, cause the one or more processors to perform operations comprising:
receiving first data representing that a vehicle is being controlled based at least in part on a first trajectory determined in accordance with a nominal acceleration limit, wherein the first trajectory is associated with a lateral motion profile;
causing the vehicle to apply a maximum deceleration, a first magnitude of the maximum deceleration being greater than the nominal acceleration limit and a second magnitude of a second deceleration associated with a safety trajectory associated with responding to an event;
receiving second data representing a measured velocity associated with the vehicle at a first time;
determining, based at least in part on the measured velocity and the maximum deceleration, a predicted velocity associated with the vehicle at a second time after the first time;
determining, based at least in part on the lateral motion profile and the predicted velocity, a second trajectory for returning the vehicle to nominal operations;
determining third data representing whether to control the vehicle based at least in part on the second trajectory; and
controlling the vehicle based at least in part on the third data.

7. The one or more non-transitory computer-readable media of claim 6, wherein:
the first trajectory is associated with at least one of decelerating or accelerating within the nominal acceleration limit,
the second deceleration is associated with decelerating based on a lower-bound deceleration defined by the nominal acceleration limit, and
the maximum deceleration is associated with decelerating more than the lower-bound deceleration.

8. The one or more non-transitory computer-readable media of claim 6, wherein determining the second trajectory comprises determining a predicted longitudinal position associated with the second time.

9. The one or more non-transitory computer-readable media of claim 8, wherein determining the predicted longitudinal position is based on a measured longitudinal position associated with the first time, the measured velocity associated with the first time, and the predicted velocity associated with the second time.

10. The one or more non-transitory computer-readable media of claim 6, wherein controlling the vehicle comprises, based on determining to refrain from controlling the vehicle based on the second trajectory, continuing to control the vehicle based on the maximum deceleration.

11. The one or more non-transitory computer-readable media of claim 10, wherein determining to refrain from controlling the vehicle based on the second trajectory is based on at least one of:
a failure likelihood associated with at least one of the vehicle or an environment of the vehicle,
a failure severity associated with at least one of the vehicle or the environment, or
whether a time associated with determining whether to refrain from controlling the vehicle based on the second trajectory is within a period after detecting the event.

12. The one or more non-transitory computer-readable media of claim 10, wherein determining to refrain from controlling the vehicle based on the second trajectory comprises making a determination within a time limit.

13. The one or more non-transitory computer-readable media of claim 6, the operations further comprising determining the first magnitude.

14. The one or more non-transitory computer-readable media of claim 13, wherein determining the first magnitude is based on at least one of:
a road incline,
a road surface type,
a road condition,
a weather condition,
a wind condition,
an air density,
an air temperature,
an air pressure,
an engine temperature,
a vehicle altitude,
a tire condition,
a weight associated with the vehicle,
a vehicle fuel quality,
availability of regenerative braking,
a condition associated with a brake system of the vehicle, or
a condition associated with a suspension control of the vehicle.

15. The one or more non-transitory computer-readable media of claim 6, wherein the second trajectory comprises following the lateral motion profile and being at a predicted longitudinal position associated with the second time.

16. A method comprising:
receiving first data representing that a vehicle is being controlled based at least in part on a first trajectory determined in accordance with a nominal acceleration limit, wherein the first trajectory is associated with a lateral motion profile;
causing the vehicle to apply a maximum deceleration, a first magnitude of the maximum deceleration being greater than the nominal acceleration limit and a second magnitude of a second deceleration associated with a safety trajectory associated with responding to an event;
receiving second data representing a measured velocity associated with the vehicle at a first time;
determining, based at least in part on the measured velocity and the maximum deceleration, a predicted velocity associated with the vehicle at a second time after the first time;
determining, based at least in part on the lateral motion profile and the predicted velocity, a second trajectory for returning the vehicle to nominal operations;
determining third data representing whether to control the vehicle based at least in part on the second trajectory; and
controlling the vehicle based at least in part on the third data.

17. The method of claim 16, wherein:
the first trajectory is associated with at least one of decelerating or accelerating within the nominal acceleration limit,
the second deceleration is associated with decelerating based on a lower-bound deceleration defined by the nominal acceleration limit, and
the maximum deceleration is associated with decelerating more than the lower-bound deceleration.

18. The method of claim 16, wherein determining the second trajectory comprises determining a predicted longitudinal position associated with the second time.

19. The method of claim 18, wherein determining the predicted longitudinal position is based on a measured longitudinal position associated with the first time, the measured velocity associated with the first time, and the predicted velocity associated with the second time.

20. The method of claim 16, wherein controlling the vehicle comprises, based on determining to refrain from controlling the vehicle based on the second trajectory, continuing to control the vehicle based on the maximum deceleration.
